(19) United States
(12) Patent Application Publication
(10) Pub. No.: US 2016/0307278 A1
(43) Pub. Date: Oct. 20, 2016

(54) CONTEXT SENSITIVE INFLUENCE MARKETING

(71) Applicant: Adobe Systems Incorporated, San Jose, CA (US)

(72) Inventor: Nedim Lipka, Santa Clara, CA (US)

(21) Appl. No.: 14/689,863

(22) Filed: Apr. 17, 2015

(51) Int. Cl. G06Q 50/00; G06Q 30/02

(52) U.S. Cl. CPC G06Q 50/01; G06Q 30/0201

(57) ABSTRACT

The present disclosure is directed toward systems and methods for determining influence of users within a social media community for marketing purposes. For example, systems and methods described herein involve identifying terms of a marketing campaign and accessing a user context for a user. The systems and methods further involve determining a popularity metric and a relevance metric for the user based on the terms of the marketing campaign and the user context. Further, the systems and methods involve determining an influence level of the user for the marketing campaign based on the popularity metric and the relevance metric.

### CROSS REFERENCE TO RELATED APPLICATIONS

N/A

### BACKGROUND

1. Technical Field

One or more embodiments described herein relate generally to marketing through a social network. More specifically, one or more embodiments relate to identifying and engaging influential users of a social networking system.

2. Background and Relevant Art

With the advent of social networking systems, marketers direct more and more marketing efforts to audiences through social networking systems. Marketing through social networks provides an effective and convenient tool for marketers to reach out to potential customers in a cost-effective manner. For example, a marketer can reach out to users of a social networking system by way of an online marketing campaign to advertise or promote a product or brand of products. Merchants and marketers have a particular interest in social media campaigns as social networking systems often unveil interests, relationships, and opinions of the members that make up a social networking community. As such, a marketer can more effectively target one or more users of a social networking system based on their specific interests and tendencies.

Users of social networking systems often rely on the opinions and preferences of other social networking users when making purchasing decisions. In particular, a member of a social networking community will often look for information and advice from other “trusted” users within their social network. As a result, these trusted users have a great deal of influence when it comes to the purchasing decisions of friends and/or followers within a social networking community. Marketers can, therefore, potentially leverage the influence of certain influential users for the purpose of marketing a product or brand to other users of a social networking system. As such, marketers need tools for identifying influential users in order to engage with them and benefit from their influence. However, conventional tools for identifying influential social networking users suffer from various limitations and drawbacks.

For example, conventional tools for identifying influential users employ a global notion of influence based on the popularity of a user (e.g., a number of the user's followers) to determine the potential influence of the user. By so doing, a marketer can ensure that its marketing efforts are reaching a broad audience. However, such focus on popularity can disregard other important aspects related to the user or the marketing campaign. In particular, a user's influence within a social network can have no relevance to a particular product or marketing campaign. As a result, engaging such a user for the marketing campaign can yield inconsistent or poor results. As such, conventional tools for identifying and engaging influential social networking users for marketing purposes are often ineffective and fail to reach relevant members of a social media community.

The same can be said of using hashtags in social media marketing. For example, a marketer may include a hashtag within an advertisement message in order to disseminate the advertisement to a large group of people that follow, search, or otherwise view messages including the associated hashtag. Nevertheless, marketers often choose hashtags based on popularity and fail to identify hashtags that are particularly relevant to a marketing campaign and/or hashtags that facilitate communication of the advertisement to the most relevant audience. As such, conventional marketing techniques using hashtags or other search tools are also often ineffective.

Thus, current methods of influence marketing through social media suffer from several disadvantages that may lead to marketing inefficiencies and failures.

### SUMMARY

One or more embodiments described herein provide benefits and/or solve one or more of the foregoing or other problems in the art with identifying and engaging influential social networking users for marketing purposes. In accordance with one or more disclosed embodiments, an influence marketing system can identify one or more terms associated with a marketing campaign, identify user profile information for a potentially influential user, determine a popularity metric for the user, and determine a relevance metric for the user. Based on the determined popularity metric and relevance metric, the influence marketing system can determine an influence level for the user that is specific to the marketing campaign. As such, the disclosed systems and methods can more accurately predict a user's potential influence as it relates to a particular marketing campaign.

Moreover, in addition to identifying influential users, the disclosed systems and methods can facilitate identification of hashtags, search terms, links, and other search elements that are influential in effectively disseminating an advertising message to a relevant audience. For example, systems described herein can determine popularity and relevance metrics for various search elements to identify search elements that are particularly effective tools in promoting a marketing campaign. Marketers can utilize identified search elements to engage a large audience that is also relevant to the marketing campaign.

Additional features and advantages of the present invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the above-recited and other advantages and features of the present disclosure, a more particular description will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of its scope, various embodiments will be described and explained with additional specificity and detail through the use of the accompanying drawings in which:

FIG. 1 illustrates a block diagram of an environment including an influence marketing system in accordance with one or more embodiments of the present disclosure;

FIG. 2 illustrates a schematic diagram of the influence marketing system of FIG. 1 in accordance with one or more embodiments of the present disclosure;

FIG. 3 illustrates a block diagram of various components used to determine a user's influence for a marketing campaign in accordance with one or more embodiments of the present disclosure;

FIG. 4 illustrates a block diagram of various components used to determine a search element's influence for a marketing campaign in accordance with one or more embodiments of the present disclosure;

FIG. 5 illustrates a flow diagram of interactions between a client device, an influence marketing system, and a social networking system in accordance with one or more embodiments of the present disclosure;

FIG. 6 illustrates a flowchart of a method for determining an influence of a user in accordance with one or more embodiments of the present disclosure;

FIG. 7 illustrates a flowchart of a method for determining an influence of a search element in accordance with one or more embodiments of the present disclosure; and

FIG. 8 illustrates a block diagram of an exemplary computing device in accordance with one or more embodiments of the present disclosure.

### DETAILED DESCRIPTION

One or more embodiments of the present disclosure relate to systems and methods for determining influence of users within a social media community. For example, as will be disclosed in more detail below, an influence marketing system can identify one or more terms associated with a marketing campaign. The system can further generate and/or access a user context for a user of a social networking system. The user context can include profile information associated with a user and information associated with the user's social networking interactions and associated co-users (e.g., friends or followers) of the social networking system. Using the context information, the system can determine a popularity metric for the user (e.g., based on a number of the user's followers). Additionally, the system can determine a relevance metric for the user with regard to the marketing campaign based on a comparison of the one or more terms from the marketing campaign and the user context information. Finally, using the determined popularity metric and the determined relevance metric, the system can determine an influence level for the user that is specific to the marketing campaign.

The embodiments of the present disclosure provide a number of benefits and advantages over conventional methods for identifying influential users of social media. For example, using the principles described herein, a marketer can accurately identify users that have a broad outreach and an influence that is specifically relevant to the marketer's particular marketing campaign. In addition, the disclosed principles allow a marketer to identify, from among a plurality of “influential” or “popular” social media users, one or more users whose influence is most relevant to a marketing campaign and most likely to drive increased demand for a marketed product. Additionally, the disclosed principles allow a marketer to rank a plurality of social media users and identify those users that are most influential within a community of users. Further, one or more disclosed principles allow modification of various terms (e.g., marketing campaign terms) if resulting influence scores fail to provide an effective indication of which social media users are influential or popular.

The benefits of the disclosed principles extend to marketing using hashtags and other search elements (e.g., links and search terms). For example, the disclosed principles also allow a marketer to identify “influential” search elements that will be relevant to the marketer's marketing campaign. To illustrate, in accordance with the disclosed embodiments, a system can determine popularity and relevance metrics for one or more search elements. As an example, the system can determine that including a particular hashtag in a marketing message will push the message to a large audience of users within a social media community. Additionally, the system can determine whether the hashtag is particularly relevant to a marketing campaign. Specifically, the system can determine whether users who create, share, receive, or view messages with the hashtag make up a particularly relevant audience for the marketing campaign. Accordingly, the system can assist the marketer to identify influential hashtags that will drive a marketing campaign to an audience of users that are most likely to be interested in the marketing campaign.

As used herein, the term “influence marketing” may refer to marketing to a community of users by engaging one or more “influential users” or “influencers” within the community and providing marketing content to the community by way of the influential users. As used herein, an “influential user” or “influencer” may refer to any user within a community of users that has a potential influence over other users within the community. For example, an influential user may refer to a user of a social media community that has developed or is perceived as having popularity, trustworthiness, expertise, goodwill, and/or leadership among the community, and can thereby influence other users within the community.

As used herein, a “marketing campaign” may refer to a collection of activities designed to promote a product, service, or business. For example, a marketing campaign may consist of or include providing marketing content (e.g., advertisements, videos, audio content, images, links, interactive content, etc.) to one or more users by way of a social networking system (e.g., within information feeds for the one or more users). In influence marketing, a marketing campaign may include engaging an influential user of a social networking system to promote a product or business to other users of the social networking system.

As will be explained in more detail below, a marketing campaign can be associated with a collection of keywords that define, describe, or are otherwise associated with one or more aspects of the marketing campaign. For example, the collection of keywords can include terms that relate to a marketing goal, a marketing domain, a target audience (e.g., group or community), an interest area, a promoted product, and/or one any other aspect(s) of the marketing campaign. To illustrate, one or more embodiments of the collection of keywords include one or more terms that describe or relate to a product that will be promoted through the marketing campaign. Additionally, the keywords can include one or more terms that describe or are otherwise associated with users that are expected to be interested in the promoted product. Additionally, the collection of keywords can include one or more terms associated with one or more topics of interest that are related to a particular product. The collection of keywords for the marketing campaign can include any other terms that are descriptive of or associated with the corresponding marketing campaign, as will be discussed in more detail below.

In addition, as used herein, the terms “electronic marketing content,” “marketing content,” or simply “content” may refer to any form of digital data or media transmitted over a communication network. For example, marketing content can include, but is not limited to, web pages, audio content, video content, digital images, electronic documents, electronic messages, electronic advertisements, and/or any other content. As an example, marketing content can refer to an advertisement provided to a user within an information feed via a social networking system. Further, in influence marketing, marketing content may be provided to a user of a social networking system (e.g., via an information feed) by way of other influential users of the social networking system.

The term “product” or “products,” as used herein, refers to both goods and services. For example, a product can refer to a tangible good as well as an intangible service.

As used herein, the term “user context” may refer to any number of terms associated with a user of a social networking system. In particular, a user context may refer to a textual representation of a user based on information associated with the user (e.g., from a user profile) and interactions by the user with respect to the social networking system. For example, a user context can include any number of terms from a user profile for the user of the social networking system. Further, a user context can include one or more terms that are included within or referenced by a user interaction by the user with respect to a social networking system. Moreover, a user context can include one or more terms associated with other users that are associated with a particular user. For example, a user context for a user can include terms associated with profile information and social networking interactions made by other users (e.g., followers, followees) that are associated with the user.

As used herein, “user profile information” may refer to user attributes, user characteristics, or other personal information associated with a user of the social networking system. In particular, user profile information may refer to any information or terms included within a user profile associated with a user of the social networking system. In one or more embodiments, user profile information includes demographic information, interests, hobbies, and/or other information included within a profile or account associated with the user. Additionally, user profile information may refer to information associated with one or more other users (e.g., followers, followees) that are associated with a particular user. For example, user profile information can include information including a number of followers and/or followees in addition to profile information associated with respective followers and/or followees. Moreover, in one or more embodiments, user profile information refers to content that is received, read, or otherwise consumed by a user.

As used herein, the terms “social networking interaction,” “user interaction,” or simply “interaction” may refer to user actions, characteristics of user actions, interactions between a user and other co-users, interactions by a user with respect to a social networking system, etc. For example, an interaction can refer to one or more communications associated with the user with respect to other co-users such as, for example, messages, posts, comments, ratings, shares, or other communication created, shared, or otherwise accessible to one or more co-users of the social networking system. Additionally, an interaction can include one or more characteristics or other information associated with communications between the user and other users.

Additionally, as used herein, the term “search element” refers to one or more terms that may be used in conjunction with or included within a user interaction or communication accessible to one or more users of a social networking system. For example, a search element can refer to a hashtag, link, keywords, or other tool for identifying a user, communication, topic, or subject of a communication that contains the search element. In particular, a user, marketer, or other entity may include a search element within a communication and disseminate the communication to other users within a social networking community that receive, view, or otherwise have access to any messages that include the search element. As an example, a user of a social networking system can include a hashtag within a communication and post the communication to be viewed by any user of the social networking system associated with the user. Additionally, the hashtag can facilitate access of the communication to any user of the social networking system that performs a search for the hashtag and/or subscribes to receive messages associated with or including the hashtag.

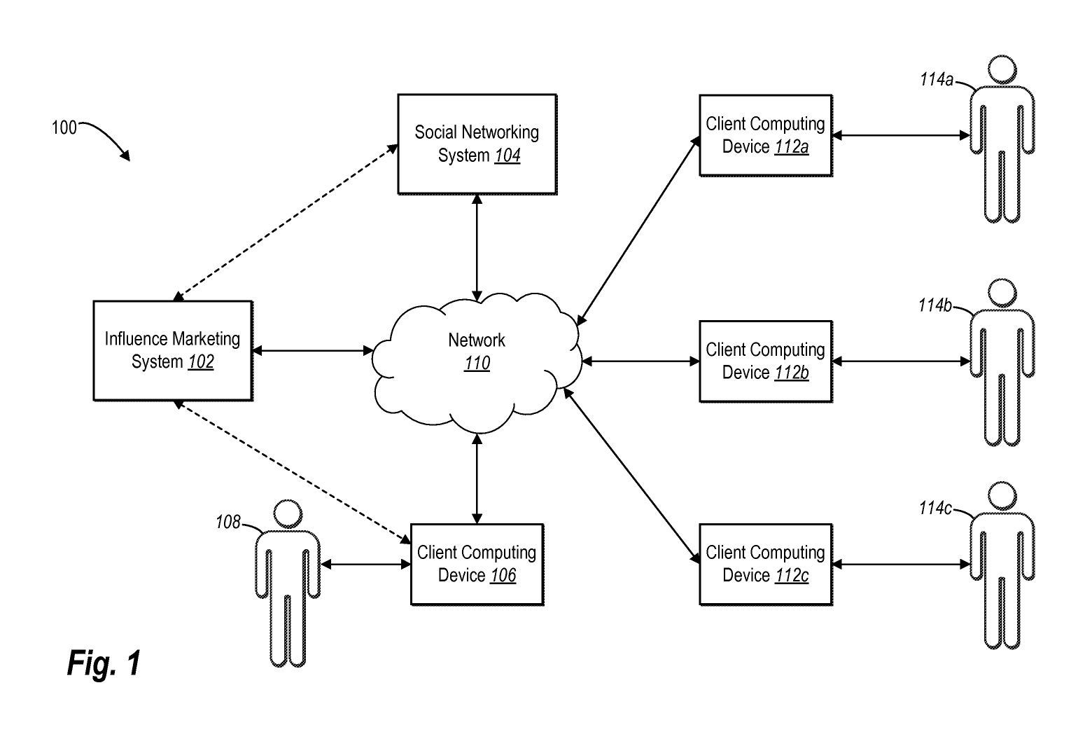

FIG. 1 is a schematic diagram illustrating an environment/system 100 in which an influence marketing system 102 can function in accordance with one or more embodiments. As illustrated in FIG. 1, the system 100 can include an influence marketing system 102 that communicates with a social networking system 104, a client device 106, and one or more additional client devices 112a-c over a network 110. Although FIG. 1 illustrates a particular arrangement of the social networking system 104, and various client devices 106, 112a-c, the system 100 can include alternative configurations. For example, the client device 106, social networking system 104, and/or one or more additional client devices 112a-c can communicate with the influence marketing system 102, bypassing the network 110. Moreover, in one or more embodiments, the influence marketing system 102 is integrated within the social networking system 104, implemented as part of the social networking system 104, or provided in conjunction with the social networking system 104.

Additionally, while the social networking system 104 may represent a single social networking platform, it is appreciated that the social networking system 104 may represent multiple social networking platforms. For example, the user 108 can represent a user of multiple social networking platforms having different user profiles for each social networking platform. Additionally, it is appreciated that various co-users 114a-c of the social networking system 104 can represent users of different social networking platforms including one or more co-users that are users of multiple social networking platforms. Moreover, in one or more embodiments, the social networking system 104 is implemented by a third-party provider that stores information associated with users of the social networking system 104. Alternatively, a third-party provider may provide one or more features (e.g., data storage) of the social networking system 104 on a separate device or system from the social networking system 104.

In some embodiments, the influence marketing system 102 can interface with the social networking system 104 for accessing information associated with various users of the social networking system 104 and/or facilitating dissemination of marketing content to a target group of users or otherwise engaging with different users of the social networking system 104. For example, the influence marketing system 102 may communicate with the social networking system 104 by way of the network 110. Alternatively, as shown in FIG. 1, the influence marketing system 102 optionally interfaces with the social networking system 104 directly and/or via an alternative communication channel from the network 110.

As mentioned above, the system 100 can include one or more users. For example, the system 100 may include a user 108 associated with a client device 106 that communicates with the influence marketing system 102, the social networking system 104 and one or more co-users of the social networking system 104. In some embodiments, the user 108 is associated with a marketer, merchant, or other entity that provides marketing by way of the social networking system 104. As illustrated in FIG. 1, the user 108 can communicate with the influence marketing system 102 via the client device 106 by way of the network 110. Alternatively, as shown in FIG. 1, the user 108 optionally communicates with the influence marketing system 102 via the client device directly or via an alternative communication channel from the network 110. In a yet further embodiment, client computing device 106 is an integral part of the influence marketing system 102.

As mentioned above, the system 100 may include any number of users of the social networking system 104. For example, as illustrated in FIG. 1, the system 100 can include one or more co-users 114a-c associated with respective client devices 112a-c that communicate with and/or access the social networking system 104 by way of respective client devices 112a-c. In some embodiments, the co-users 114a-c make up a community of users within the social networking system 104. For example, the co-users 114a-c can represent general users of a social networking system 104 or more specifically represent a community of users having similar interests or belonging to a user group. Additionally, in some embodiments, the user 108 is a user of the social networking system 104 and belongs to a community of users in common with one or more of the co-users 114a-c.

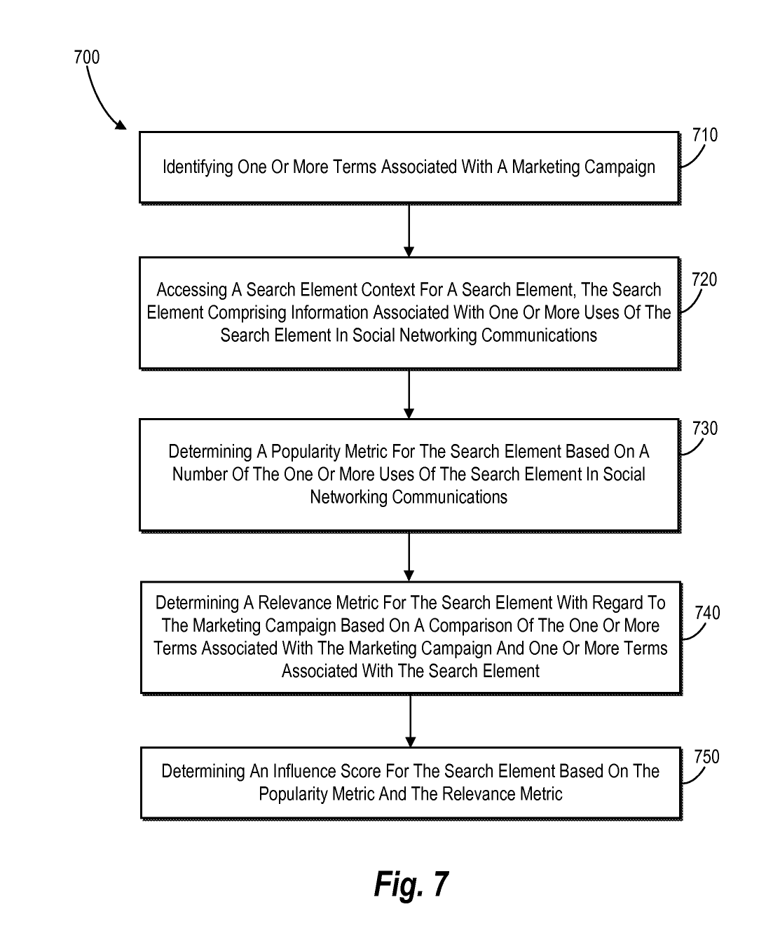

While FIG. 1 illustrates only a few client devices and corresponding users, the system 100 can include any number of client devices and corresponding users of the social networking system 104. Further, the users of corresponding client devices may communicate with each other via the social networking system 104. Examples of client devices can include, but are not limited to, mobile devices (e.g., smartphones, tablets, smart watches), laptops, desktops, or other type of computing device, such as those described below in connection with FIG. 7.

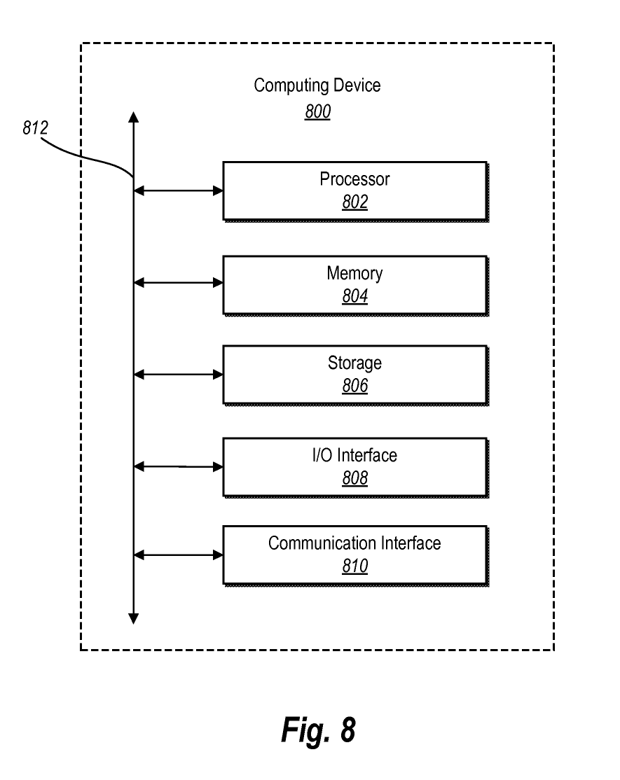

Additionally, as stated above, the influence marketing system 102, social networking system 104, client device 106, and additional client devices 112a-c may communicate through the network 110. In one or more embodiments, the network 110 includes the Internet or World Wide Web. The network 110 may include other types of networks that use various communication technology and protocols, such as a corporate intranet, a virtual private network (VPN), a local area network (LAN), a wireless local network (WLAN), a cellular network, a wide area network (WAN), a metropolitan area network (MAN), near field communication network, or a combination of two or more such networks. Additional networks and network features are described below in connection with FIG. 8.

As mentioned above, the influence marketing system 102 can access information associated with a user to determine an influence level of the user with respect to a marketing campaign. In particular, as will be explained in greater detail below, the influence marketing system 102 can generate and/or access a user context for a user of the social networking system 104 that includes information associated with the user and further compare the user context with one or more terms from a marketing campaign to calculate an influence score for the user that is specific to the marketing campaign. The influence marketing system 102 can further compare the user context and terms from a marketing campaign for any number of users (e.g., a community of users) and calculate an influence level for each of the different users. For example, the influence marketing system 102 can access a user context for each of the co-users 114a-c and compare each of the user contexts with terms from a marketing campaign to calculate an influence level for each of the co-users 114a-c.

In determining an influence level and identifying influential users, the influence marketing system 102 can consider various types of metrics based on information associated with users of the social networking system 104. For example, the influence marketing system 102 can determine a popularity metric for a user based on, for example, a number of followers, followees, and/or a number of co-users of the social networking system 104 otherwise associated with the user. Additionally, the influence marketing system 102 can determine a relevance metric for the user (e.g., with respect to a marketing campaign) based on a user context including attributes, characteristics, actions, communications, or other information associated with the user. Further, the influence marketing system 102 can consider the popularity metric, relevance metric, and other information associated with the user and associated co-users to determine an influence level of the user for a marketing campaign. Additional details with regard to determining an influence level for one or more users will be described in additional detail below.

In addition to determining an influence level and identifying influential users, the influence marketing system 102 can promote a product and/or facilitate dissemination of marketing content to various users of the social networking system 104 by engaging one or more influential users. For instance, where a first co-user 114a is identified as an influential user among the co-users 114a-c that belong to a common group of users (e.g., a common-interest group) or are otherwise associated with the first co-user 114a (e.g., follower/followee), the influence marketing system 102 can engage the second co-user 114b and the third co-user 114c by way of the first co-user 114a. As an example, the influence marketing system 102 or the social networking system 104 communicates marketing content to the first co-user 114a to be viewed or otherwise shared with other co-users 114b-c as well as any additional co-users of the social networking system 104 that are associated with the first co-user 114a.

Moreover, in addition to determining an influence score for a user or group of users, the influence marketing system 102 can determine an influence score for one or more search elements (e.g., hashtags, key words, links) and identify one or more specific search elements that are particularly influential for a marketing campaign. In particular, the influence marketing system 102 can determine a popularity metric, relevance metric, and/or other metrics associated with a search element and identify whether the search element is influential with regard to a marketing campaign and/or among a target group of users of the social networking system 104. For example, the influence marketing system 102 can determine whether attaching a particular search element with a communication (e.g., a post) will reach a broad and relevant audience of users of the social media network and more effectively promote a product associated with the marketing campaign.

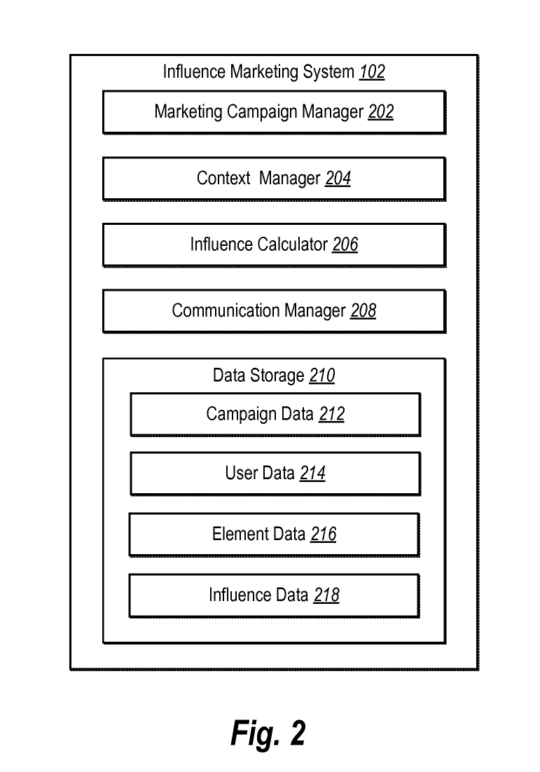

FIG. 2 illustrates a schematic diagram illustrating an example embodiment of the influence marketing system 102. In one or more embodiments, the influence marketing system 102 can include a marketing campaign manager 202, a context manager 204, an influence calculator 206, a communication manager 208, and a data storage 210. Although the disclosure illustrated in FIG. 2 shows the components 202-210 to be separate, any of the components 202-210 may be combined into fewer components, such as into a single facility module, or divided into more components as may serve one or more embodiments. In addition, the components 202-210 may be located on, or implemented by, one or more servers or other computing devices, such as those described below in relation to FIG. 8.

The components 202-210 can comprise software, hardware, or both. For example, the components 202-210 can comprise one or more instructions stored on a computer readable storage medium and executable by a processor of one or more computer devices. When executed by the one or more processors, the computer-executable instructions of the influence marketing system 102 can cause a computing device(s) to perform the methods described herein. Alternatively, the components 202-210 can comprise hardware, such as a special-purpose processing device to perform a certain function. Additionally or alternatively, the components 202-210 can comprise a combination of computer-executable instructions and hardware.

In one or more embodiments, the influence marketing system 102 can perform various tasks that provide tools and services to one or more merchants or marketers. For example, the influence marketing system 102 can access information associated with various users (e.g., user context) of a social networking system 104 and identify influential users within a community of users. Further, the influence marketing system 102 can facilitate engaging one or more influential users by providing marketing content to the influential users and/or providing marketing content to a community of users by way of the influential users.

In realizing features and functionality of the influence marketing system 102, a marketing campaign manager 202 can manage information associated with a marketing campaign. In particular, the marketing campaign manager 202 can model interests or goals of a marketer in a textual way by identifying any number of terms associated with a marketing campaign and/or an intended audience for the marketing campaign. In some embodiments, the marketing campaign manager 202 can generate terms for a marketing campaign based on one or more key words associated with a particular product and/or target audience. Additionally or alternatively, in some embodiments, the marketing campaign manager 202 can receive one or more terms for a marketing campaign from a marketer, merchant, or other entity and optionally generate additional terms associated with the marketing campaign.

In identifying terms for a marketing campaign, the marketing campaign manager 202 may receive, generate, or otherwise identify a vocabulary including terms that are descriptive or otherwise associated with a product, brand, or merchant that the marketing campaign is intended to promote. As an example, for a marketing campaign directed to promoting a recent version of Photoshop, one or more marketing terms include terms related to photography. In this example, the marketing campaign manager 202 identifies terms such as “animals, art, beautiful, camcorder, camera, capture, cmos, colors, create, creative, creativity, design, digital, etc.” It is appreciated that the marketing campaign manager 202 may identify any number of terms associated with one or multiple products, brands, or merchants for a particular marketing campaign. Further, one or more vocabulary terms associated with a marketing campaign may further include one or more discriminative terms capable of determining whether associated content is unrelated to the marketing campaign. For example, in one or more embodiments, the marketing campaign manager 202 identifies one or more terms that, when included within a communication, indicate that the communication is likely not related to or otherwise associated with a marketing campaign.

In addition to identifying terms associated with a product or brand, the marketing campaign manager 202 can define a vocabulary including terms that are descriptive or otherwise associated with an intended audience or target users of the social networking system 104 for whom a marketing campaign is intended to reach. As an example, one or more marketing terms include terms related to an intended audience of students. In this example, the marketing campaign manager 202 identifies terms such as “annual, application, attending, baseball, basketball, beach, book, bored, campus, celebrate, classes, coffee, college, etc.” It is appreciated that the marketing campaign manager 202 may identify any number of terms associated with one or multiple target audiences for the marketing campaign.

As mentioned above, the influence marketing system 102 can further include a context manager 204 that generates and/or manages a user context for various users of the social networking system 104. In some embodiments, the context manager 204 receives or generates a user context based on information from a user profile and/or a record or history of user interactions (or simply “interactions”) by the user with respect to the social networking system 104. As such, the user context can include a textual representation based on a record or history of information and interactions for a particular user including, but not limited to, user attributes, user characteristics, user actions, characteristics of user actions, interactions (e.g., communications) between the user and co-users of the social networking system 104, interactions with respect to content posted by co-users, identifiers of co-users (e.g., followers and followees), and/or other information associated with one or more interactions of a user with respect to the social networking system 104. In one or more embodiments, the context manager 204 receives a user context for one or more users from the social networking system 104. Alternatively, the context manager 204 may generate a user context for one or more users based on information received from the social networking system 204.

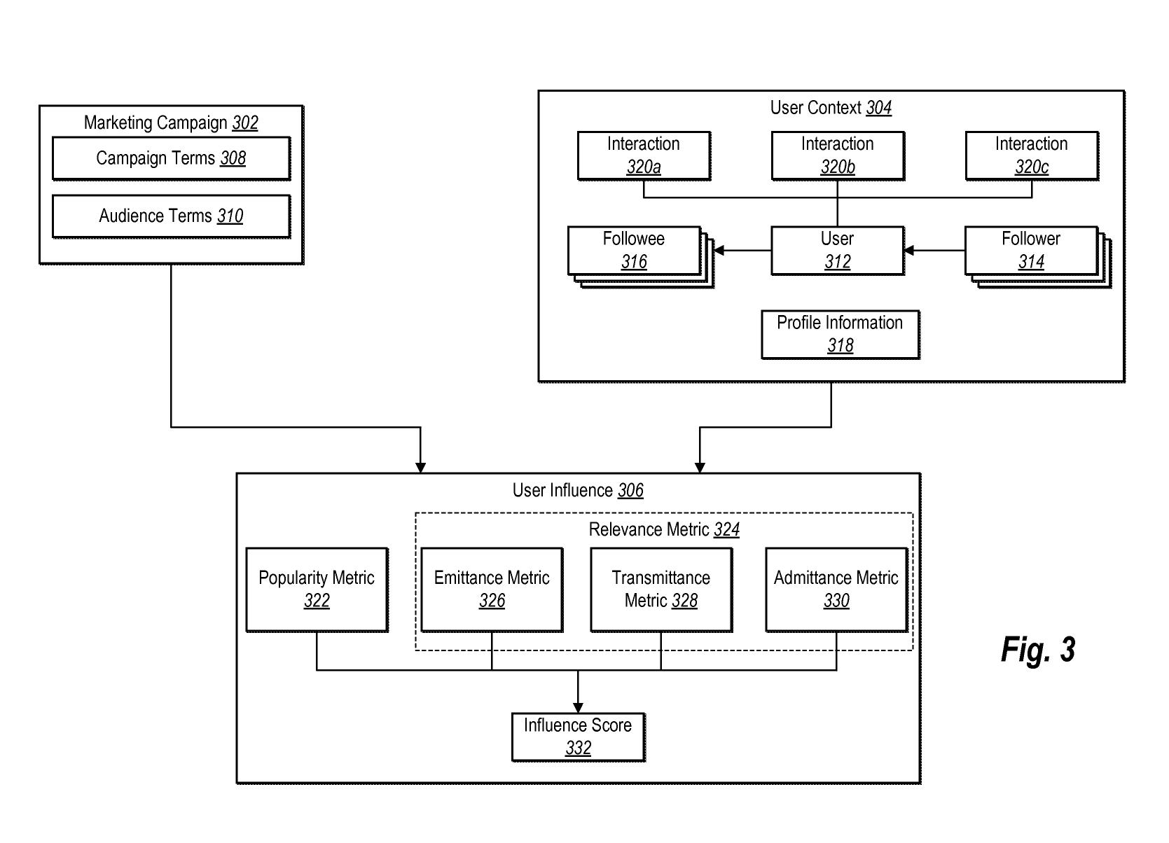

As mentioned above, the context manager 204 can receive or generate a user context for a user that includes information about interactions of the user with respect to the social networking system 104 as well as information about various co-users associated with the user. For example, as will be discussed further in connection to FIG. 3, a user context can include profile information such as demographic information, interests, hobbies, and/or any information included within a profile or account associated with the user. Additionally, a user context can include information about co-users of the social networking system 104 associated with the user, such a number of followers, followees, and information (e.g., profile information) associated with the various followers and followees of the user. Furthermore, a user context can include information about various interactions with respect to or otherwise accessible to co-users of the social networking system 104. For example, a user context for a user can include a record of messages, posts, comments, shares, or other communications created, shared, or otherwise accessible to co-users of the social networking system 104 that are associated with the user.

As mentioned above, the influence marketing system 102 can further include an influence calculator 206 that determines an influence level of a user based on various metrics. In particular, the influence calculator 206 can consider terms of a marketing campaign, user context, and/or one or more additional terms that are significant to a particular marketer and determine an influence level for a user with regard to the marketing campaign. For example, as will be described in greater detail below, the influence calculator can determine a popularity metric for a user and a relevance metric for the user and determine an influence level for the user with respect to a marketing campaign based on the popularity metric and the relevance metric.

In calculating a popularity metric and/or relevance metric(s), the influence calculator 206 may consider a user context associated with a user and calculate a context-sensitive notion of influence with regard to the marketing campaign. More specifically, the influence calculator 206 employs a topic similarity measure ((p) in determining the similarity between two different texts (e.g., terms from a marketing campaign and terms from a user context). The influence calculator 206 calculates any number of similarity measures between terms associated with a marketing campaign and various types of information associated with a user (e.g., user profile information), a user's interactions (e.g., posts and other communications), and a user's co-users (e.g., followers). For example, as will be explained in greater detail below, the influence calculator 206 can calculate a similarity measure for each of a user's followers based on a comparison of terms for a marketing campaign to information (e.g., user context) associated with each of the respective followers. The influence calculator 206 can further calculate a popularity metric for the user based on the calculated similarity measures for the user's followers, as explained in more detail below. As another example, the influence calculator 206 can calculate a similarity measure for each of multiple interactions (e.g., communications) based on a comparison of terms for the marketing campaign to the text associated with each interaction. As a yet further example, the influence calculator 206 can calculate a similarity measure for a user based on a comparison of terms for the marketing campaign to user profile information associated with the user. The influence calculator 206 can then calculate one or more relevance metrics based on the calculated similarity measures as explained in more detail below.

The similarity measure (φ) can include one or more similarity measures used in information retrieval such as the Jaccard similarity between two sets of words or the cosine similarity between two vector-based representations. In at least one example, the influence calculator 206 considers normalized similarity measures (e.g., cosine similarity) that range from 0 (no similarity) to 1 (maximum similarity). For instance, in the case of cosine similarity φ_{cos}, a text (x) (e.g., keywords or other text for a marketing campaign, text from a user context) may be represented as a numeric vector (x) that indicates the word frequencies. More specifically, the cosine similarity between a first text x_{A} (e.g., text associated with a marketing campaign) and a second text x_{B} (e.g., text associated with a user context) can be represented with the following equation:

$$ϕ cos ( {x}_{A} , {x}_{B} ) := \frac{{x}_{A} \cdot {x}_{B}}{‖ {x}_{A} ‖ ‖ {x}_{B} ‖}$$

As shown in more detail below, the influence calculator 206 can calculate a similarity measure using the above equation for any two texts or groups of text.

As mentioned above, the influence calculator 206 can determine a popularity metric for a user. The popularity metric can be based on a variety of factors that indicate a user's popularity within a social community. In particular, the influence calculator 206 can identify a number of followers associated with the user and calculate a popularity metric based on the number of followers. In some embodiments, the influence calculator 206 can further consider a number of followees associated with the user. Further, the influence calculator 206 can consider any number of co-users of the social networking system 104 that are associated with the user, are likely to be influenced by the user, and/or have access to one or more communications posted by the user on the social networking system 104.

While some embodiments of the popularity metric consider only a number of co-users associated with the user, the influence calculator 206 can further consider a user context associated with each of various followers and/or followees of the user. For example, in one or more embodiments, the influence calculator 206 calculates a popularity metric by calculating a similarity measure for each co-user of a social networking system 104 that is following the user based on a comparison of a user context for each follower to terms associated with a marketing campaign. Further, the influence calculator 206 calculates a summation of each similarity measure of each follower and calculates a log function of the calculated sum. As such, the popularity metric is not only influenced by a number of followers, but also influenced by the respective similarity measures for each of the followers, thereby providing a context-sensitive popularity metric. As mentioned above, in one or more embodiments, the influence calculator considers only the user context of followers. Alternatively, the influence calculator 206 may also consider the user context of followees.

In at least one example, a popularity metric (Pₘ) for a user is calculated using the following equation:

$${P}_{m} ( C , M ) := {log}_{γ 1} ( 1 + {\sum }_{\begin{matrix}{m}^{′} ∈ \\ FOLLOWERS\end{matrix}} ϕ ( {C}_{{m}^{′}} , M ) )$$

where C refers to a context of a user, M refers to one or more campaign terms associated with a marketing campaign, C_{m′} refers to the context of a follower, and φ refers to a similarity measure (e.g., cosine similarity) between a context of a follower and terms associated with the marketing campaign.

In a further example, the influence calculator 206 considers metrics other than the number and context of followers and followees in calculating a popularity metric. In particular, the influence calculator 206 may also consider a number and context of one or more listings associated with the user and/or co-users (e.g., followers, followees). For example, in one or more embodiments, the influence calculator 206 calculates a summation of similarity measures for each follower and calculates a log function of the calculated sum. Additionally, the influence calculator 206 calculates a summation of similarity measures for each communication or interaction associated with one or more of the followers and calculates a log function of the resulting sum. Moreover, in one or more embodiments, the influence calculator 206 weights each of the sums using different weighting factors to place an emphasis on different sources of information associated with followers and/or communications associated with followers.

In at least one example, a popularity metric (Pₘ) that considers listings associated with followers is calculated using the following equation:

$${P}_{m} ( C , M ) := {w}_{1} {log}_{γ 1} ( 1 + {\sum }_{\begin{matrix}{m}^{′} ∈ \\ FOLLOWERS\end{matrix}} ϕ ( {C}_{{m}^{′}} , M ) ) + {w}_{2} {log}_{γ 2} ( 1 + {\sum }_{\begin{matrix}{m}^{′} ∈ \\ LISTINGS\end{matrix}} ϕ ( {C}_{{m}^{′}} , M ) )$$

where C refers to the context of the user, M refers to one or more campaign terms associated with the marketing campaign, C_{m′} refers the context of a follower, φ refers to a similarity measure (e.g., cosine similarity) between a follower's context (Cm′) and the one or more campaign terms (M), and where the impact of the summands can be additionally controlled by weighting factors (ω) and by the bases (γ) of the logarithms. While follower context and the listing context may be weighted using any number of weighting factors, in one or more embodiments, the influence calculator 206 can implement weightings that are inversely proportional to the sum of the weighted followings. In at least one example, the weighting factors (ω) are represented using the following equation:

$${w}_{i ∈ \{ 1 , 2 \}} ∝ {\sum }_{\begin{matrix}{m}^{″} ∈ \\ FOLLOWINGS\end{matrix}} ϕ ( {C}_{{m}^{″}} , M )$$

where Followings is the set of followed users associated with the user and C_{m″} refers to the context of followees associated with the user.

In addition to determining a popularity metric, the influence calculator 206 can also determine a relevance metric based on profile information and/or information associated with interactions of the user with respect to co-users and the social networking system. In some embodiments, the relevance metric includes a combination of multiple relevance metrics. For example, as will be described in greater detail below, one or more embodiments of a relevance metric includes an emittance metric, a transmittance metric, and/or an admittance metric.

As mentioned above, a relevance metric may include an emittance metric for the user that characterizes an amount of content (e.g., interactions) generated and distributed by a user of the social networking system 104. Further, the emittance metric can characterize an amount of content forwarded by the user and/or one or more co-users associated with the user. For example, the emittance metric may characterize an amount of content generated by the user and subsequently forwarded by one or more co-users. Additionally, the emittance metric may consider the recency of one or more interactions by the user with respect to the social networking system 104. For example, in one or more embodiments, the influence calculator 206 calculates an emittance score for a particular interaction by calculating a ratio between a cosine similarity (e.g., between terms of an interaction and terms of a marketing campaign) and the recency of the user interaction. Additionally, the influence calculator 206 calculates an emittance score based on a calculated sum of ratios for each interaction generated and distributed by the user and performs a log function of the resulting sum. As a result, a more recent interaction (e.g., having a lower recency value) would result in a higher ratio value than a less recent interaction having similar terms. Additionally, an interaction having a high similarity measure would result in a greater ratio than another interaction (of a similar recency) having a low similarity measure.

In at least one example, an emittance metric (Eₘ) is calculated using the following equation:

$${E}_{m} ( C , M ) := {log}_{γ} ( 1 + {\sum }_{\begin{matrix}x ∈ \\ MESSAGES / \\ FORWARDINGS\end{matrix}} \frac{ϕ ( x , M )}{r ( x )} )$$

where C refers to the context of the user, M refers to one or more campaign terms associated with the marketing campaign, r(x) refers to the recency of an interaction (x), and φ refers to a similarity measure (e.g., cosine similarity) between text associated with the interaction and the one or more campaign terms of the marketing campaign. In one example, the interaction for each sum refers to a communication (e.g., post, tweet, etc.) generated and distributed by the user. Additionally, as mentioned above, one or more interactions can refer to one or more forwardings from the user and/or one or more co-users associated with the user. As used herein, a “forwarding” refers to any action taken with respect to a communication that results in accessibility to one or more co-users of the social networking system 104. For example, a forwarding may refer to a tweet, re-tweet, share, link, like, rating, comment, post, or other type of action that results in content becoming accessible to one or more co-users associated with the user. A forwarding can be from the user herself, forwarding content from another originating user. Additionally or alternatively, a forwarding can be from a user's follower(s) forwarding content originating from the user. Regardless of the source of the forwarding and/or the underlying content, the influence calculator 206 can take the forwarding into account when determining a corresponding metrics (e.g., relevance metrics).

Additionally, as mentioned above, a relevance metric may include a transmittance metric for the user that characterizes an amount and relevancy of content forwarded from the user to other users. Further, the transmittance metric can be based on content (e.g., on an amount of content and/or a relevance of content) forwarded by the user and/or one or more co-users associated with the user. For example, in one or more embodiments, the transmittance metric is based on content forwarded by a user that does not necessarily originate from the user. Additionally or alternatively, the transmittance metric can be based on content forwarded by co-users associated with the user, whether or not the content originates from the user. Similar to the emittance metric, the transmittance metric may also consider the recency of one or more interactions in determining the transmittance metric. For example, in one or more embodiments, the influence calculator 206 calculates a transmittance score for a particular interaction (e.g., a forwarded communication) by calculating a ratio between a similarity measure and the recency of the user interaction. Additionally, the influence calculator 206 calculates a transmittance score based on a calculated sum for each interaction forwarded by the user and perform a log function of the resulting sum. As a result, a more recent interaction (e.g., having a lower recency value) would result in a higher ratio value than a less recent interaction having similar terms. Additionally, an interaction having a high similarity measure would result in a greater ratio than another interaction (of a similar recency) having a low similarity measure.

In at least one example, a transmittance metric (Tₘ) is calculated using the following equation:

$${T}_{m} ( C , M ) := {log}_{γ} ( 1 + {\sum }_{\begin{matrix}x ∈ \\ FORWARDINGS\end{matrix}} \frac{ϕ ( x , M )}{r ( x )} )$$

where C refers to the context of the user, M refers to one or more campaign terms associated with the marketing campaign, r(x) refers to the recency of an interaction (x), and φ refers to a similarity measure (e.g., cosine similarity) between text associated with the interaction and campaign terms of the marketing campaign.

As shown in the equation above, the transmittance metric (Tₘ) can refer specifically to interactions of the user related to communications (e.g., posts, messages, comments) that are forwarded (e.g., re-tweeted, shared, linked, liked) by a user. In some embodiments, forwarded communications include messages from a social media account associated with the marketer that are subsequently forwarded by the user. In addition to tracking a number and recency of forwards from the user, the transmittance metric may provide an indication of a probability that a user will forward a message to followers, which provides an effective metric for specific marketing strategies (e.g., influence marketing).

Additionally, as mentioned above, a relevance metric may include an information admittance metric (or simply “admittance metric”) that applies a similar definition of the emittance metric while limiting a considered set of interactions (e.g., communications) to interactions that contain an element of set K corresponding to relevant search elements (e.g., hashtags, keywords, links) and/or terms with a particular relevance to the marketing campaign. For example, in one or more embodiments, the element of set K includes one or more terms or search elements that are specifically designated by a marketer as having a high level of importance for the marketing campaign. In this way, the admittance metric identifies interactions and other content that have a direct connection to a marketers account or which include terms that are particularly important to a marketer or merchant. In one or more embodiments, the element set of K includes terms not otherwise included in the terms associated with the marketing campaign. Alternatively, the element set of K may include one or more terms and/or search elements that are included within the terms of the marketing campaign that have been designated as particularly important to the marketing campaign.

Further, similar to the emittance and transmittance metrics, the admittance metric may consider the recency of interactions by the user with respect to the social networking system 104. For example, in one or more embodiments, the influence calculator 206 calculates an admittance metric for an interaction by calculating a ratio between a cosine similarity (e.g., between terms of terms of an interaction and terms of a marketing campaign) and the recency of the user interaction. Additionally, the influence calculator 206 calculates an admittance score based on a calculated sum for each interaction originating and/or forwarded by the user that includes a designated term or element (e.g., element K) and a recency of the interaction. Additionally, the influence calculator 206 calculates an admittance score based on a calculated sum for each interaction generated and distributed by the user and perform a log function of the resulting sum. As a result, a more recent interaction (e.g., having a lower recency value) would result in a higher ratio value than a less recent interaction having similar terms. Additionally, an interaction having a high similarity measure would result in a greater ratio than another interaction (of a similar recency) having a low similarity measure.

In at least one example, an admittance metric (Yₘ) is calculated using the following equation:

$${Y}_{m} ( C , M , K ) := {log}_{γ} ( 1 + {\sum }_{\begin{matrix}x ∈ \\ MESSAGES containing s ∈ K / \\ FORWARDINGS\end{matrix}} \frac{ϕ ( x , M )}{r ( x )} )$$

where C refers to the context of the user, M refers to one or more campaign terms associated with the marketing campaign, K refers to specific terms and/or search elements (e.g., hashtags, key words, links) associated with the marketer or marketing campaign, r(x) refers to the recency of an interaction (x), and φ refers to a similarity measure (e.g., cosine similarity) between text of interactions and the one or more terms of the marketing campaign.

Using one or a combination of the emittance metric, the transmittance metric, and/or the admittance metric, the influence calculator can calculate a corresponding relevance metric. In some embodiments, the influence calculator 206 can weight each of the emittance metric, the transmittance metric, and/or the admittance metric in order to manage the effect of each metric on the overall relevance metric.

Upon determining a popularity metric and a relevance metric, the influence calculator 206 may further determine an influence level for the user based on the popularity metric and/or relevance metric. For example, in one or more embodiments, the influence calculator 206 calculates an influence score for a user with regard to a marketing campaign based on a combination of the popularity metric and one or more of the relevance metrics (i.e., the emittance metric, the transmittance metric, and/or the admittance metric). Further, in one or more embodiments, the influence calculator 206 considers other metrics in calculating an influence score for a user. For example, the influence calculator 206 can calculate a similarity measure between terms of a marketing campaign and terms associated with a user profile, consumed or produced content, tracked purchases, or other information that may be included within a user context when determining the relevance of a user to a marketing campaign.

Additionally, in some embodiments, the influence calculator 206 weights one or more metrics with respect to other metrics. For example, in one or more embodiments, a popularity metric is weighted with respect to one or more relevance metrics in calculating the influence score. In some embodiments, the influence calculator 206 weights any one or more of the metrics differently from other metrics (e.g., based on marketing considerations). In at least one example, the influence calculator 206 calculates an influence score (S) using the following equation:

S(C,M,K):=β₁P(C,M)+β₂E(C,M)+β₃T(C,M)+β₄Y(C,M,K)

where C refers to the context of the user, M refers to one or more campaign terms associated with the marketing campaign, K refers to one or more terms, key words, or search elements (e.g., in addition to the campaign terms (M)) associated with the merchant, marketer, and/or marketing campaign, P refers to a popularity metric, E refers to an emittance metric, T refers to a transmittance metric, and Y refers to an information admittance metric. Further, each of β₁, β₂, β₃, and β₄ can refer to different weightings for each of the different metrics. In some embodiments, a marketer or other entity calibrates the weightings depending on a marketing strategy. In at least one example, the popularity metric receives the largest weight while the importance of the emittance metric, transmittance metric, and/or admittance metric vary. Additionally, where a particular weighting or calculation of an influence scores results in a dense ranking of users, fails to exceed a particular threshold, or otherwise fails to provide an influence score that is helpful in determining one or more influential users, a marketer (or other entity) can adjust the weighting values to more effectively determine the relevance of one or more users with respect to various marketing terms. Additionally, the marketer may adjust one or more marketing campaign terms in determining influence scores for particular users.

Upon determining the influence level (e.g., influence score) for one or more users of the social networking system 104, the marketing system 102 may identify one or more influential users of the social networking system 104 based on associated influence scores. For example, in one or more embodiments, the influence marketing system 102 identifies a user having the highest influence score within a community of users as an influential user within the community. Alternatively, the influence marketing system 102 may identify any number of users having an influence score above a predetermined threshold as influential users within a particular community. In another example, the influence marketing system 102 identifies a particular percentile (e.g., top-10%) of influence scores as influence scores that corresponding to influential users of the social networking system 104. Further, in one or more embodiments, the influence marketing system 102 ranks one or more users according to their influence score and identifies influential users based on their ranking relative to other users of the social networking system 104. Other criteria and thresholds may also be used to identify one or more influential users and/or scores corresponding to influential users.

Upon identifying one or more influential users, the influence marketing system 102 may engage with one or more of the influential users in various methods for marketing to users of the social networking system 104. For example, as described above, the influence marketing system 102 can implement influence-based marketing by providing marketing content to one or more influential users. For instance, where a marketer is launching a beta campaign, the marketing system 102 can specifically target only influential users in order to gauge success or gather information about launching the product to other users having similar interests or profiles to the influential users. Further, the marketing system 102 can use the influential users as a platform to launch a particular product and allow influential users that are likely to comment, discuss, forward, or otherwise influence others with respect to the product.

In addition to providing marketing content to influential users, the influence marketing system 102 can market to co-users or a larger community of users via the influential users. For example, the influence marketing system 102 can post marketing content to a communication feed of an influential user that is associated with a large number of relevant co-users that have access to the influential user's communication feed. Additionally or alternatively, the influence marketing system 102 can provide marketing content to an influential user who frequently rates, comments, forwards, or otherwise interacts with received marketing content and who could provide additional publicity for the marketing content by forwarding the marketing content and influencing a community of co-users that are associated with the user. Additionally, the influence marketing system 102 may use any number of influence-based marketing techniques in marketing to users of the social networking system 104 to, with, or through identified influential users of the social networking system 104.

Moreover, while many of the above embodiments are described in reference to determining popularity and relevance metrics for various users or members of a social networking system 104 and identifying influential users among the users, one or more features of the above embodiments may relate to groups of users, a list, a hub or company account, or other entity or plurality of entities that could have an influence on other entities within the social networking system 104 and/or to whom marketing content is provided. For example, in one or more embodiments, the influence marketing system 102 determines an influence level of a particular group of users with respect to other users of the social networking system 104.

Further, while many embodiments described herein relate specifically to determining an influence level and identifying influential users of a social networking system 104, many features and functionalities described above in connection with determining an influence level of users may also apply to determine an influence level of search elements. In particular, one or more embodiments of the influence marketing system 102 also determine an influence level of various search elements (e.g., hashtags, keywords, links) and identify one or more search elements that would be influential with respect to a marketing campaign. For example, in one or more embodiments, the influence marketing system 102 receives and/or generates a search element context from the social networking system 104. Further, as will be described in greater detail below, the influence marketing system 104 may determine popularity and relevance metrics for various search elements and identify one or more search elements that are particularly influential for a marketing campaign.

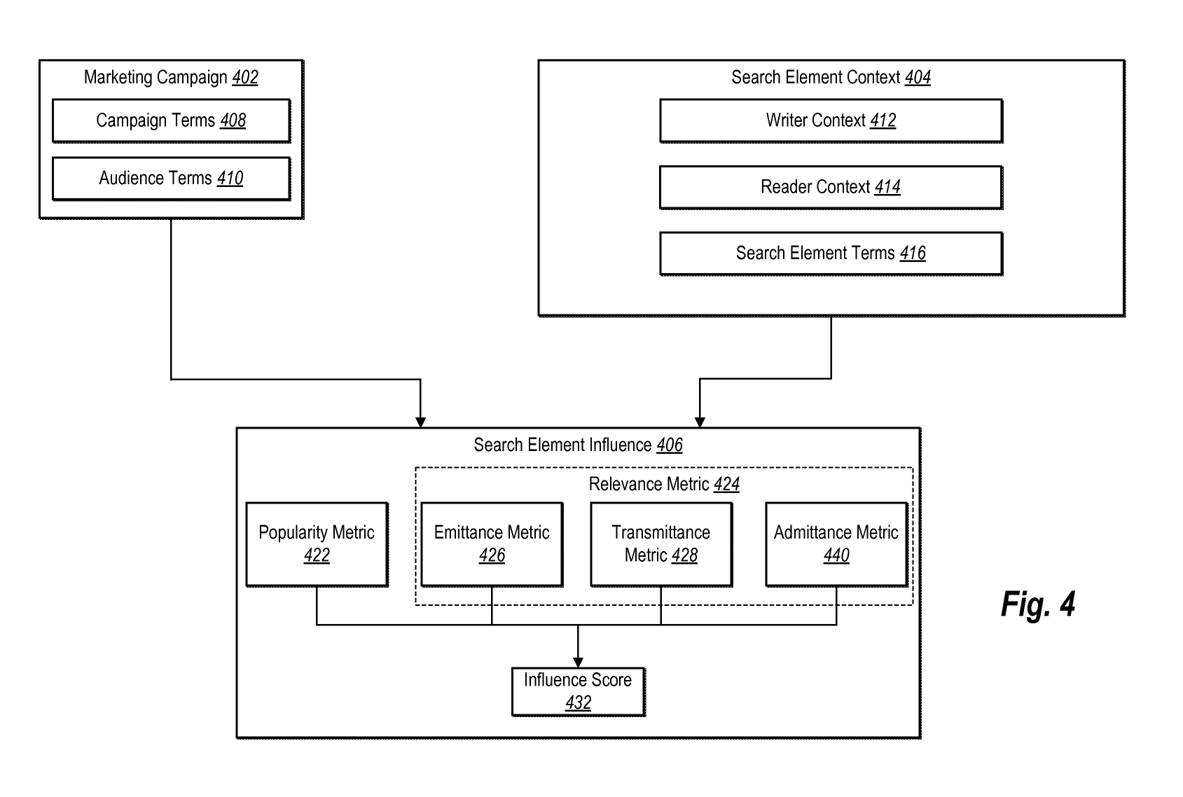

As mentioned above, similar to determining various metrics for a user with regard to a marketing campaign, the influence marketing system 102 may receive and/or generate a context for the search elements. In particular, a context for a search element may include context for a writer of the search element, context for one or more readers or followers of the search element, and a textual representation of the search element itself including one or more search element terms. For example, in one or more embodiments, the influence marketing system 102 generates and maintains a search element context that includes one or more terms corresponding to a user that creates and/or transmits the search element, one or more terms corresponding to one or more co-users that receive or otherwise have access to an interaction of the user including the search element, and one or more terms included within the search element itself. Additional detail with regard to search element context is described below in reference to FIG. 4.

Additionally, similar to the description above with regard to determining an influence level for a user, the influence marketing system 102 may determine a popularity score and relevance score for a search element using similar features as described above. For example, in one or more embodiments, the influence calculator 206 calculates a popularity metric and a relevance metric including, for example, an emittance metric, a transmittance metric, and an information admittance metric. In calculating various metrics associated with search elements, the influence calculator 206 can employ various topic similarity measures, including, for example, the cosine similarity measure as described above. Additionally, the influence calculator 206 can employ a similar formula for calculating a total influence score for a search element or other term similar to the equation for calculating the influence score described above.

As mentioned above, the influence calculator 206 may determine a popularity metric of a search element (e.g., a term). For example, in one or more embodiments, the influence calculator 206 calculates a sum of similarity measures for each writer of a search element and calculates a sum of similarity measures for each reader of a search element. Further, the influence calculator 206 weights each of the sums using different weighting factors to place an emphasis on writers or readers of communications associated with a search element.

In at least one example, the popularity metric (Pₜ) is calculated using the following equation:

$${P}_{t} ( C , M ) := {w}_{1} {log}_{γ 1} ( 1 + {\sum }_{\begin{matrix}{m}^{′} ∈ \\ {WRITERS}_{t}\end{matrix}} ϕ ( {C}_{{m}^{′}} , M ) ) + {w}_{2} {log}_{γ 2} ( 1 + {\sum }_{\begin{matrix}{m}^{′} ∈ \\ {READERS}_{t}\end{matrix}} ϕ ( {C}_{{m}^{′}} , M ) )$$

where C refers to the context of the search element, M refers to one or more campaign terms associated with the marketing campaign, C_{m′} refers to the context of a writer or reader associated with a respective interaction containing the search element, φ refers to a similarity measure (e.g., cosine similarity) between a writer or reader context (C_{m′}) and campaign terms (M). Additionally, writerₜ and readerₜ may include multiple sets of uses by the same users. For example, where a search element or term (m′) occurs multiple times with respect to a communication or multiple communications from a user, the summation can include multiple values that correspond to the same user. Additionally, similar as described above with regard to the popularity metric (Pₘ), the impact of the summands can be controlled by weighting factors (ω) and by the bases (γ) of the logarithms in calculating the popularity metric (Pₜ).

In some embodiments, the popularity metric only considers occurrence of terms with respect to writers or creators of various interactions (e.g., communications). Additionally, as shown in the equation above, the popularity metric (Pₜ) may consider one or more readers having access to the interactions from the writers. In some embodiments, the readers include any user having access to an interaction (e.g., communication) from a writer. Alternatively, influence marketing system 102 may implement various impression metrics to account only for users that have actually viewed, read, or otherwise interacted with the interaction.

In addition to the popularity metric, the influence calculator 206 may compute a relevance metric, including one or more metrics associated with a relevancy of the search element with respect to the marketing campaign. For example, in one or more embodiments, the relevance metric includes an emittance metric that characterizes how often a specific term or search element occurs in created interactions or other content and weighted with respect various campaign terms (e.g., marketing goals, domain description) associated with the marketing campaign. Additionally, the emittance metric may consider a recency of interactions associated with the search element. For example, in one or more embodiments, the influence calculator 206 calculates an emittance score for a search element by calculating a ratio between a similarity measure between terms. Additionally, the influence calculator 206 calculates an emittance score by calculating a sum of ratios for each interaction generated and distributed by the user including the search element and perform a log function of the resulting sum. As a result, a more recent interaction (e.g., having a lower recency value) would result in a higher ratio value than a less recent interaction having similar terms. Additionally, an interaction having a high similarity measure would result in a greater ratio than another interaction (of a similar recency) having a low similarity measure.

In at least one example, an emittance metric (Eₜ) is calculated using the following equation:

$${E}_{t} ( C , M ) := {log}_{γ} ( 1 + {\sum }_{\begin{matrix}x ∈ \\ {MESSAGES}_{t} / \\ FORWARDINGS\end{matrix}} \frac{ϕ ( x , M )}{r ( x )} )$$

where C refers to the context of the search element, M refers to one or more campaign terms associated with the marketing campaign, r(x) refers to the recency of an interaction (x), and φ refers to a similarity measure (e.g., cosine similarity) between terms of the interaction and one or more terms associated with the search element. In some embodiments, the influence calculator 206 computes the emittance metric (Eₜ) based solely on content within created interactions and excludes forwardings, shares, or other transmittals in which the content is not originally created by the user associated with the interaction. Additionally, the set of interactions represented by the emittance metric (Eₜ) may represent interactions associated with all users of the social networking system 104, a particular community of users (e.g., a user group) of the social networking system 104, or any subset of users of the social networking system 104.

Additionally, as mentioned above, the relevance metric may include a transmittance metric that characterizes how often a specific term or search element occurs in forwarded content and weighted by its relevance with respect to one or more terms of a marketing campaign. Similar to the emittance metric, the transmittance metric may also consider the recency of one or more interactions that include a particular search element in determining the transmittance metric. For example, in one or more embodiments, the influence calculator 206 calculates a transmittance score for a particular interaction (e.g., a forwarded communication) by calculating a ratio between a similarity measure and the recency of the user interaction. Additionally, the influence calculator 206 calculates a transmittance score based on a calculated sum for each interaction forwarded by the user and perform a log function of the resulting sum. As a result, a more recent interaction (e.g., having a lower recency value) would result in a higher ratio value than a less recent interaction having similar terms. Additionally, an interaction having a high similarity measure would result in a greater ratio than another interaction (of a similar recency) having a low similarity measure.

In at least one example, the transmittance metric (Tₜ) is calculated using the following equation:

$${T}_{t} ( C , M ) := {log}_{γ} ( 1 + {\sum }_{\begin{matrix}x ∈ \\ {FORWARDINGS}_{t}\end{matrix}} \frac{ϕ ( x , M )}{r ( x )} )$$

where C refers to the context of the search element, M refers to the one or more campaign terms associated with the marketing campaign, r(x) refers to the recency of an interaction (x), and φ refers to a similarity measure (e.g., cosine similarity) between terms of the interaction and one or more terms associated with the search element. Additionally, similar to the emittance metric (Eₜ), the set of interactions represented by the transmittance metric (Eₜ) may represent interactions associated with all users of the social networking system 104, a particular community of users, or any subset of users of the social networking system 104.

Further, as mentioned above, the relevance metric may include an information admittance metric (or simply “admittance metric”) that characterizes how often the search element co-occurs with other terms or search elements that have a particular importance or significance to the marketing campaign. Similar to the emittance and transmittance metrics, the admittance metric can consider the recency of interactions by the user with respect to the social networking system 104. For example, in one or more embodiments, the influence calculator 206 calculates a ratio between a similarity measure and recency of an interaction and calculates a sum of the ratios for each interaction (e.g., communication) that includes a specific element or term. Additionally, the influence calculator 206 performs a log function of the resulting sum to determine the admittance metric. As a result, a more recent interaction (e.g., having a lower recency value) would result in a higher ratio value than a less recent interaction having similar terms. Additionally, an interaction having a high similarity measure would result in a greater ratio than another interaction (of a similar recency) having a low similarity measure.

In at least one example, the admittance metric (Yₜ) is calculated using the following equation:

$${Y}_{t} ( C , M , K ) := {log}_{γ} ( 1 + {\sum }_{\begin{matrix}x ∈ \\ {MESSAGES}_{t} containing s ∈ \{ K \backslash t \} \backslash \\ FORWARDINGS\end{matrix}} \frac{ϕ ( x , M )}{r ( x )} )$$

where C refers to the context of the search element, M refers to one or more campaign terms associated with the marketing campaign, and K refers to one or more additional search elements or terms that co-occur within various interactions with the search element. Further, r(x) refers to the recency of an interaction (x) including the search element and other significant terms or elements and φ refers to a similarity measure (e.g., cosine similarity) between terms of the relevant interactions and terms of the marketing campaign. In some embodiments, the set of interactions represent only those messages that include both the search element and one or more identified terms or search elements of importance or significance to the marketing campaign.

Additionally, similar to other features described above, the influence calculator may determine an influence level for a particular search element and identify one or more search elements that are particularly influential for a marketing campaign. Further, the influence marketing system 102 can utilize the identified search elements in conjunction with delivering marketing content to specific users, groups of users, or general users of the social networking system 104.

Furthermore, in realizing features and functionality of the influence marketing system 102, a communication manager 208 can manage communication between the influence marketing system 102 and one or more additional devices over the network. In particular, the communication manager 208 can facilitate retrieval of information from the social networking system 104 such as user context for various co-users 114a-c or search element context for one or more search elements. Further, the communication manager 208 can facilitate communication of marketing content to the social networking system 104 and/or to client devices 112a-c associated with respective co-users 114a-c. Additionally, the communication manager 208 can facilitate communication between the influence marketing system 102 and the client device 106 associated with a user 108. For example, in one or more embodiments, the communication manage 208 facilitates retrieval of campaign terms or other terms of interest to a marketer from the client device 106.

Moreover, as mentioned above, and as illustrated in FIG. 2, the influence marketing system can include a data storage 210 including campaign data 212, user data 214, and influence data 216. In particular, the campaign data 212 can include data representative of one or more terms associated with or descriptive of a marketing campaign, product, brand, or merchant. The campaign data 212 can also include data representative of one or more audience terms descriptive of a target audience or other audience of interest. It is appreciated that the campaign data 212 may include information associated with any number of marketing campaigns.

The user data 214 may include data representative of information associated with one or more users of a social networking system 104. In particular, the user data 214 can include any number of terms that are descriptive of users, interactions associated with users, and/or information associated with related users (e.g., followers, followees) that are connected to or otherwise associated with one or more users of the social networking system 104. For example, in one or more embodiments, the user data 214 represents a user context for any number of users of the social networking system 104. Further, in addition to user data 214, the data storage 210 can include element data 216 associated with one or more search elements (e.g., hashtags, search terms, links). For example, one or more embodiments of the element data 216 represent search element context for any number of search elements and/or information related to the writer and/or reader of the search elements.

The influence data 218 may include data representative information associated with an influence level for a user, search element, or other object capable of influencing users of the social networking system 104. For example, in one or more embodiments, influence data 218 includes calculated influence scores for one or more users based on a comparison of terms of a marketing system and associated user context of the one or more users. Additionally, the influence data 218 may include an identification of one or more influential users or search elements with regard to various marketing campaign based on respective influence scores.

Additionally, while not explicitly shown in FIG. 2, the data storage 210 may further include information associated with the social networking system 104. For example, in one or more embodiments, the influence marketing system 102 implements a web crawler or other crawling software that generates a network snapshot that includes data representative of the social networking system 104. Additionally, social networking data may include other information received from the social networking system 104 or users of the social networking system 104.

FIG. 3 illustrates a block diagram illustrating an example marketing campaign 302 and an example user context 304 in accordance with one or more embodiments of the present disclosure that may be used to determine a user influence 306 with respect to the marketing campaign 302. In particular, as described above, influence marketing system 102 can analyze one or more terms of the marketing campaign 302 and one or a combination of terms of the user context 304 to determine a user influence 306 among other users with regard to the marketing campaign 302.

As shown in FIG. 3, the marketing campaign 302 includes one or more campaign terms 308. In particular, the campaign terms 308 can include any number of terms based on marketing goals, a domain description, or any information associated with a marketer, merchant, or product that is being promoted via the marketing campaign. For example, where the marketing campaign 302 is for skiing products for a particular merchant, the campaign terms 308 can include terms such as “active, adventures, alaskan, alpine, arapahoe, avalanche, boots, christmas, equipment, freestyle, etc.” It is appreciated that the campaign terms 308 may include any number of terms associated with a marketer, merchant, brand, or product that a marketing campaign 302 is promoting.

Additionally, as shown in FIG. 3, one or more embodiments of the marketing campaign 302 include one or more audience terms 310 that are descriptive or otherwise associated with a target audience or other audience of interest with respect to the marketing campaign 302. In particular, the audience terms 310 may include any number of terms that link a user to a topic of interest or link the user to a particular demographic of users that are relevant to a particular marketing campaign. For example, where a marketing goal is aimed at raising awareness to students about a product or brand of the marketing campaign, the audience terms 310 can include student-related terms such as “annual, application, attending, baseball, basketball, beach, book, bored, campus, celebrate, classes, coffee, college, etc.” or any number of terms commonly associated with students.

Additionally, as shown in FIG. 3, a user context 304 includes an identifier of a user 312 and information associated with the user 312. For example, as illustrated in FIG. 3, the user context 304 includes identifiers of one or more followers 314 and identifiers of one or more followees 316. Further, while the user context 304 may include any type of information about a user 312, in one or more embodiments, the user context 304 further includes various types of information about associated followers 314 and followees 316 (e.g., co-user context). For example, one or more embodiments of the user context 304 include co-user context for each of the followers 314 and followees 316 similar to the user context 304 of the user 312. It is also appreciated that the user 312, follower(s) 314, and followees(s) 316 may include similar features and characteristics as the user 108 and co-users 114a-c described above in connection with FIG. 1.

As shown in FIG. 3, the user context 304 includes profile information 318 associated with the user 312. In one or more embodiments, the profile information 318 includes information such as demographic information, interests, hobbies, and/or any information included within a profile or account associated with the user. In some embodiments, the profile information 318 includes any information accessible to co-users of the social networking system 104 that are associated with the user 312. (e.g., followers 314, followees 316) Alternatively, the profile information 318 may include information accessible to the social networking system 104 that is not otherwise accessible to co-users of the social networking system 104.

Further, one or more embodiments of the user context 304 include a record of interactions 320a-c associated with the user 312. For example, in one or more embodiments, the user context 304 includes a textual representation corresponding to communications, or various actions performed by the user 312 with respect to the social networking system 104 and/or with respect to co-users of the social networking system 104. In some embodiments, the user context 304 includes textual representations of different types of interactions 320a-c associated with the user 312. For example, a first interaction 320a can include a message that the user 312 has composed and transmitted to one or more co-users. Further, a second interaction 320b can include a comment or rating that the user 312 has posted to a co-user's profile or newsfeed. Further, a third interaction 320c can include a communication that the user 312 did not create, but forwarded or shared with one or a group of co-users associated with the user 312. It is appreciated that the user context 304 may include any number and type of interactions that the user 312 has performed with respect to the social networking system 104 and/or with respect to other co-users of the social networking system 104.

As described above, the influence marketing system 102 may compare the user context 304 for a user 312 and one or more terms of the marketing campaign 302 to determine a user influence 306 associated with the user 312. In particular, the influence marketing system 102 may calculate a popularity metric 322 and a relevance metric 324, including, for example, an emittance metric 326, a transmittance metric 328, and/or an admittance metric 330. For example, in one or more embodiments, the influence marketing system 102 calculates the popularity metric 322, emittance metric 326, transmittance metric 328, and admittance metric 330 for the user as described above.

Furthermore, as shown in FIG. 3, the user influence 306 may include an influence score 332 based on a combination of one or more metrics. For example, in one or more embodiments, the influence marketing system 102 calculates an influence score 332 based on the popularity metric 322, emittance metric 326, transmittance metric 328, and admittance metric 330. In some embodiments, the influence marketing system 102 calculates the influence score 332 based on a weighted combination of the various metrics as described above in connection with FIG. 2.

FIG. 4 illustrates a block diagram illustrating an example marketing campaign 402 and an example search element context 404 in accordance with one or more embodiments of the present disclosure that may be used to determine a search element influence 406 with respect to the marketing campaign 402. In particular, one or more terms of the marketing campaign 402 may be compared to one or a combination of terms of the search element context 404 with regard to the marketing campaign 402.

As shown in FIG. 4, a marketing campaign 402 may include one or more campaign terms 408 and one or more audience terms 410. The marketing campaign 402, including campaign terms 408 and audience terms 410 may be similar to the marketing campaign 302, including campaign terms 308 and audience terms 310 described above in connection with FIG. 3.

Further, as shown in FIG. 4, the search element context 404 may include a writer context 412, reader context 414, and search element terms 416. In particular, the writer context 412 and reader context 414 may refer to a user context (e.g., similar to the user context 304 described in connection with FIG. 3) of one or more writers (e.g., creators) of a particular search element and one or more readers or other users having access to or who have viewed a search element. It is appreciated that one or more writers or readers may correspond to the same user that has composed, shared, received, or otherwise interacted with the social networking system 104 using a search element multiple times. For example, where a user has forwarded multiple messages that each includes one or more instances of a search element, the writer context 412 may include multiple user contexts that correspond to the same user.

Additionally, as shown in FIG. 4, the search element context 404 may include search element terms 416. In one example, the search element terms 416 includes one or more terms included within a search element. In a further example, the search element terms 416 includes one or more terms included within a communication or other interaction that is shared or otherwise communicated together with the search element. For instance, where a search element refers to a particular hashtag, a search element term 416 may refer to a term included within the hashtag (e.g., a term included within text of the hashtag) or one or more terms included within messages that are commonly shared in conjunction with the hashtag.

As described above, the influence marketing system 102 may compare the search element context 404 and one or more terms of the marketing campaign 402 and determine a search element influence 406. In particular, the influence marketing system 102 may calculate a popularity metric 422 and a relevance metric 424, including an emittance metric 426, transmittance metric 428, and/or admittance metric 430. Further, the influence marketing system 102 may calculate the influence score 432 for the search element based on a combination of the one or more metrics. In some embodiments, the influence marketing system 102 calculates the influence score 432 based on a weighted combination of the various metrics as described above in connection with FIG. 2.

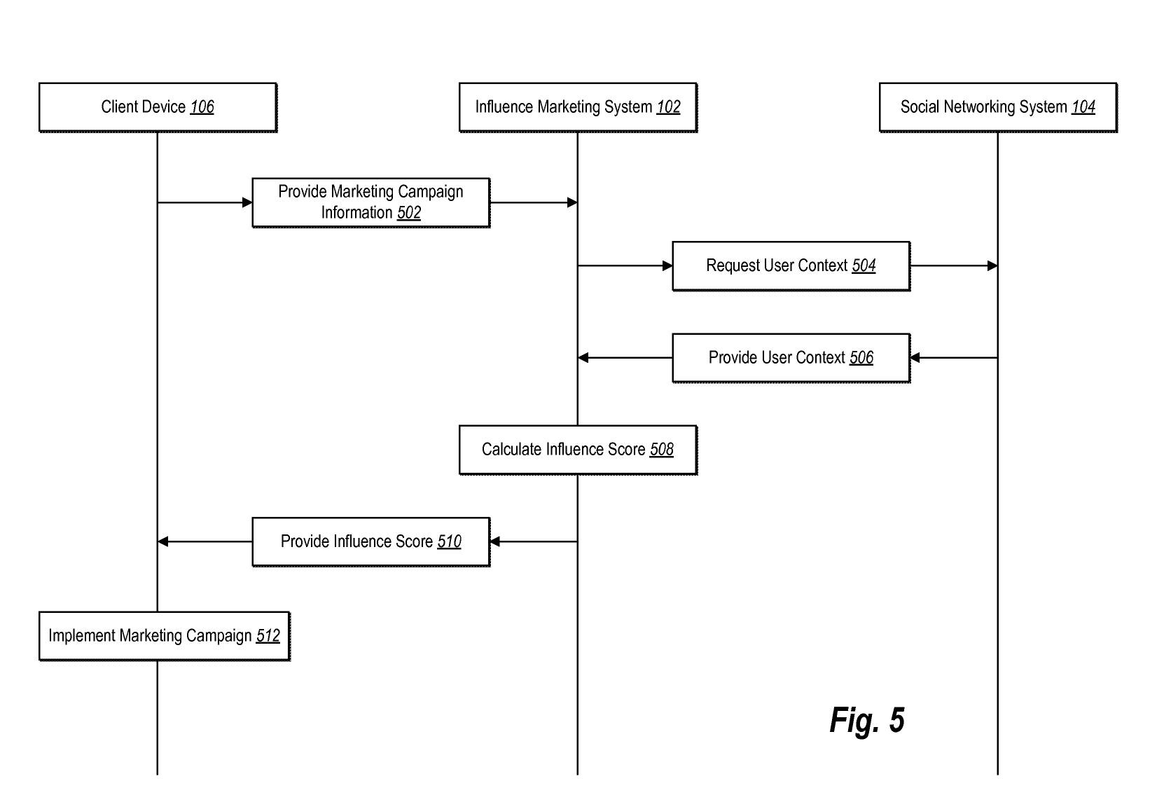

FIG. 5 illustrates a flow diagram of interactions between a client device 106, influence marketing system 102, and a social networking system 104 in accordance with one or more embodiments described herein. In particular, FIG. 5 illustrates one example embodiment for accessing a user context for a user and determining an influence score for the user with respect to a marketing campaign.

As shown in FIG. 5, a client device 106 may provide 502 marketing campaign information to the influence marketing system 102. In particular, the client device 106 may provide the marketing campaign information on behalf of a marketer, merchant, or other entity having an interest in implementing the marketing campaign among users of the social networking system 104. Additionally, providing the marketing campaign information may include providing any number of terms (e.g., campaign terms, audience terms) associated with a product, brand, merchant, and/or target group of users associated with one or more goals of the marketing campaign.

The influence marketing system 102 may also request 504 a user context for one or more users of the social networking system 104. For example, in one or more embodiments, the influence marketing system 102 requests a user context for each user within of a group of co-users 114a-c for which a marketing campaign is targeted. In response to the request, the social networking system 104 provides 506 the user context for one or more users of the social networking system 104 to the influence marketing system 102. For example, the social networking system 104 may provide the user context for each user within the group of co-users 114a-c for which the marketing campaign is targeted.

Upon receiving the user contexts, the influence marketing system 102 calculates 508 an influence score for one or more users corresponding to the user contexts. In particular, the influence marketing system 102 may compare one or more terms of the marketing campaign and one or more terms from the user contexts and determine an influence score indicative of a popularity and relevance of one or more users of the social networking system 104. For example, as described above, the influence marketing system 102 can calculate an influence score based on a popularity metric and a relevance metric, including one or more of an emittance metric, transmittance metric, and an admittance metric.

The influence marketing system further provides 510 the influence score to the client device 106. Additionally or alternatively, the influence marketing system 102 may provide an influence level or identification of one or more influential users of the social networking system 104 to the client device 106. Upon receiving the influence score or other influence indicator(s), the client device 106 implements 512 the marketing campaign among users of the social networking system 104. For example, the client device 106 may implement an influence marketing campaign among co-users 114a-c of the social networking system 104.

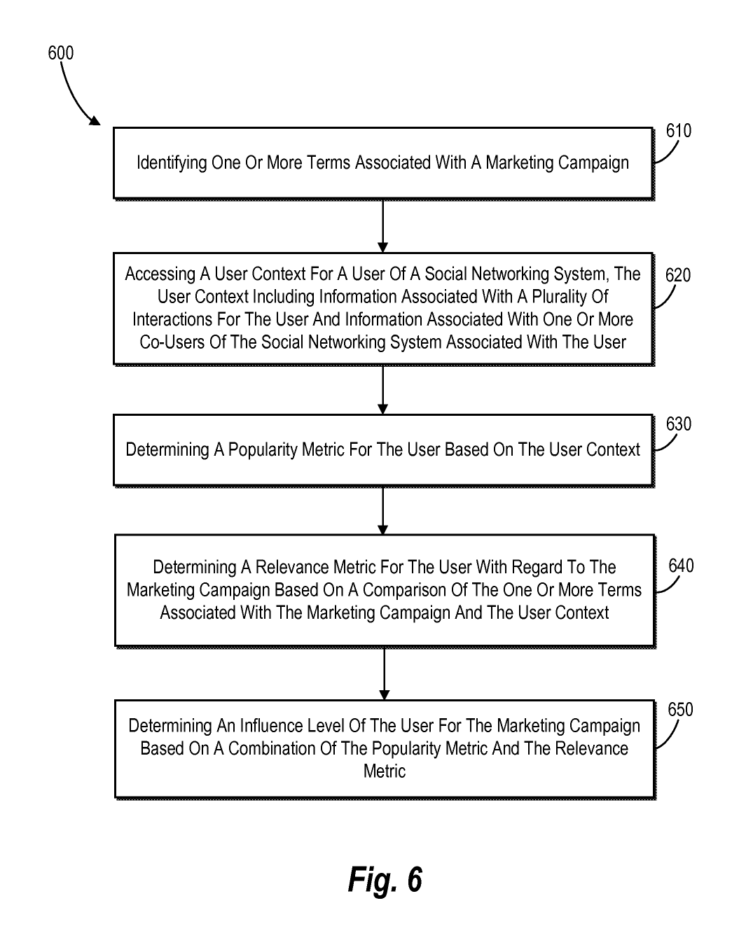

FIGS. 1-5, the corresponding text, and the examples, provide a number of different systems and devices for determining an influence level of users and/or search elements within a social networking system 104. In addition to the foregoing, one or more embodiments can also be described in terms of flowcharts comprising acts and steps in a method for accomplishing a particular result. For example, FIGS. 6 and 7 illustrate flowcharts of exemplary methods in accordance with one or more embodiments. The methods described in relation to FIGS. 6 and 7 may be performed with less or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart of one example method 600 of determining influence of users within a social media community in accordance with one or more embodiments of the present disclosure. The method 600 includes an act 610 of identifying one or more terms associated with a product or merchant associated with the marketing campaign. Further, the act 610 can involve identifying one or more descriptive terms of a target audience for the marketing campaign.

The method 600 further includes an act 620 of accessing a user context for a user of a social networking system. The act 620 can involve receiving the user context from a social networking system. Further, in one or more embodiments, the user context includes information associated with a plurality of interactions for the user including, for example, one or more terms contained within one or more communications associated with the user with respect to one or more co-users of the social networking system. The user context can further include information associated with one or more co-users of the social networking system associated with the user including, for example, one or more terms from profile descriptions associated with the one or more co-users.

The method 600 further includes an act 630 of determining a popularity metric for the user (e.g., based on user context). In some embodiments, the act 630 involves calculating a number of co-users associated with the user and determining the popularity metric based on the number of co-users (e.g., number of followers). Additionally, the act 630 can involve calculating the probability metric based on information (e.g., user context) associated with followers of the user (e.g., from the one or more co-users). Furthermore, the act 630 can involve identifying each of the co-users that are relevant to the marketing campaign and calculating the popularity metric based on information associated with each of the identified co-users that are relevant to the marketing campaign.

The method 600 can further include an act 640 of determining a relevance metric for the user with regard to the marketing campaign based on a comparison of the one or more terms associated with the marketing campaign and the user context. In some embodiments, the act 640 involves identifying one or more interactions created by the user (e.g., from the plurality of interactions) and calculating an emittance metric for the user based on a comparison of terms from the marketing campaign and one or more terms from the identified interaction(s) created by the user. Further, in some embodiments, the act 640 involves identifying one or more interactions forwarded by the user (e.g., from the plurality of interactions) and calculating a transmittance metric for the user based on a comparison of terms from the marketing campaign and one or more terms from the identified interaction(s) forwarded by the user. Additionally, in some embodiments, the act 640 involves identifying one or more interactions (e.g., from the plurality of interactions) containing a search element (e.g., hashtag, search term, link) that is relevant to the marketing campaign and determining an information admittance metric for the user based on a comparison of terms from the marketing campaign and one or more terms from the identified interactions containing the search element.

The method 600 further includes an act 650 of determining an influence level of the user for the marketing campaign based on a combination of the popularity metric and the relevance metric. The act 650 involves calculating an influence score for the user. Further, the act 650 can involve weighting the popularity metric and the relevance metric using different weighting factors. In some embodiments, the act 650 involves weighting the popularity metric more heavily than the relevance metric. Additionally, the act 650 can involve weighting a popularity metric, emittance metric, transmittance metric, and information admittance metric using a separate weighting factor for each metric. Further, in one or more embodiments, the act 650 involves weighting the popularity metric more heavily than any one or a combination of the emittance metric, transmittance metric, and the information admittance metric.

Further, while not shown in FIG. 6, the method 600 can further include an act of determining an influence level for each user within a group of users. Further, the method 600 can include an act of identifying, within the group of users, one or more influential users having a higher influence level than the other users within the group of users. Additionally, the method 600 can include an act of implementing a marketing campaign. For example, the method 600 can include an act of providing marketing content associated with the marketing campaign to one or more influential users and/or providing marketing content associated with the marketing campaign to the group of users by way of the identified one or more influential users.

FIG. 7 illustrates a flowchart of one example method 700 of determining an influence level of a search element within a social media community. The method 700 includes an act 710 of identifying one or more terms associated with a marketing campaign. Additionally, the method 700 includes an act 720 of accessing a search element context that includes information associated with one or more uses of the search element in the social networking system. The search element can include one or more of a hashtag, link, or a search term.

The method 700 further includes an act 730 of determining a popularity metric for the search element based on one or more uses of the search element in social networking communications. The act 730 can further involve identifying one or more interactions from the plurality of interactions that include one or more instances of the search element and calculating the relevance metric based on a comparison of the terms associated with the marketing campaign and one or more terms included within the identified one or more interactions.

The method 700 further includes an act 740 of determining a relevance metric for the search element with regard to the marketing campaign based on a comparison of the one or more terms of the marketing campaign and one or more terms included within the one or more interactions. For example, the act 740 can involve comparing terms of the marketing campaign and terms included within messages, posts, or other communications that also include the search element. Additionally, as illustrated in FIG. 7, the method 700 further includes an act 750 of determining an influence score for the search element based on the popularity metric and the relevance metric.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as an un-subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing un-subscription model can be composed of various characteristics such as, for example, on-demand self-service, broad network access, resource pooling, rapid elasticity, measured service, and so forth. A cloud-computing un-subscription model can also expose various service un-subscription models, such as, for example, Software as a Service (“SaaS”), Platform as a Service (“PaaS”), and Infrastructure as a Service (“IaaS”). A cloud-computing un-subscription model can also be deployed using different deployment un-subscription models such as private cloud, community cloud, public cloud, hybrid cloud, and so forth. In this description and in the claims, a “cloud-computing environment” is an environment in which cloud computing is employed.

FIG. 8 illustrates a block diagram of an exemplary computing device 800 that may be configured to perform one or more of the processes described above. One will appreciate that the influence marketing system 102, client device 106, and additional client devices 112a-c may be implemented by one or more computing devices such as the computing device 800. As shown by FIG. 8, the computing device 800 can comprise a processor 802, memory 804, a storage device 806, an I/O interface 808, and a communication interface 810, which may be communicatively coupled by way of a communication infrastructure 812. While an exemplary computing device 800 is shown in FIG. 8, the components illustrated in FIG. 8 are not intended to be limiting. Additional or alternative components may be used in other embodiments. Furthermore, in certain embodiments, the computing device 800 can include fewer components than those shown in FIG. 8. Components of the computing device 800 shown in FIG. 8 will now be described in additional detail.

In particular embodiments, the processor 802 includes hardware for executing instructions, such as those making up a computer program. As an example and not by way of limitation, to execute instructions, the processor 802 may retrieve (or fetch) the instructions from an internal register, an internal cache, the memory 804, or the storage device 806 and decode and execute them. In particular embodiments, the processor 802 may include one or more internal caches for data, instructions, or addresses. As an example and not by way of limitation, the processor 802 may include one or more instruction caches, one or more data caches, and one or more translation lookaside buffers (TLBs). Instructions in the instruction caches may be copies of instructions in the memory 804 or the storage 806.

The memory 804 may be used for storing data, metadata, and programs for execution by the processor(s). The memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 may be internal or distributed memory.

The storage device 806 includes storage for storing data or instructions. As an example and not by way of limitation, the storage device 806 can comprise a non-transitory storage medium described above. The storage device 806 may include a hard disk drive (HDD), a floppy disk drive, flash memory, an optical disc, a magneto-optical disc, magnetic tape, or an universal Serial Bus (USB) drive or a combination of two or more of these. The storage device 806 may include removable or non-removable (or fixed) media, where appropriate. The storage device 806 may be internal or external to the computing device 800. In particular embodiments, the storage device 806 is non-volatile, solid-state memory. In other embodiments, the storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 808 allows a user to provide input to, receive output from, and otherwise transfer data to and receive data from the computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 812 may include hardware, software, or both that couples components of the computing device 800 to each other. As an example and not by way of limitation, the communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. In a networking environment for communicating electronic content, a method for determining influence of members within a social networking community, comprising:
identifying, using at least one processor, one or more terms associated with a marketing campaign;
accessing, using the at least one processor, a user context for a user of a social networking system, the user context comprising information associated with a plurality of interactions for the user and information associated with one or more co-users of the social networking system associated with the user;
determining, using the at least one processor, a popularity metric for the user;
determining, using the at least one processor, a relevance metric for the user with regard to the marketing campaign based on a comparison of the one or more terms associated with the marketing campaign and the user context; and
determining, using the at least one processor, an influence level of the user for the marketing campaign based on a combination of the popularity metric and the relevance metric.

2. The method of claim 1, wherein the one or more terms associated with the marketing campaign comprise one or more descriptive terms of a product associated with the marketing campaign.

3. The method of claim 1, wherein identifying one or more terms associated with the marketing campaign comprises identifying one or more descriptive terms of a target audience for the marketing campaign.

4. The method of claim 1, wherein the information associated with the plurality of interactions comprises one or more terms contained within one or more communications associated with the user.

5. The method of claim 1, wherein the information associated with the one or more co-users of the social networking system comprises one or more terms from profile information associated with the one or more co-users.

6. The method of claim 1, wherein determining the popularity metric for the user comprises calculating a number of co-users that are following the user.

7. The method of claim 1, wherein determining the popularity metric comprises calculating a similarity measure between the one or more terms associated with the marketing campaign and information associated with one or more followers of the user from the one or more co-users.

8. The method of claim 1, wherein determining the popularity metric comprises:
identifying each co-user of the one or more co-users that is relevant to the marketing campaign; and
calculating a similarity measure between the one or more terms associated with the marketing campaign and information associated with each identified co-user that is relevant to the marketing campaign.

9. The method of claim 1, wherein determining the relevance metric comprises:
identifying one or more interactions of the user from the plurality of interactions; and
calculating an emittance metric for the user based on a comparison of the one or more terms associated with the marketing campaign and one or more terms from the one or more interactions of the user.

10. The method of claim 1, wherein determining the relevance metric comprises:
identifying one or more interactions forwarded by the user from the plurality of interactions; and
calculating a transmittance metric for the user based on a comparison of the one or more terms associated with the marketing campaign and one or more terms from the one or more interactions forwarded by the user.

11. The method of claim 1, wherein determining the relevance metric comprises:
identifying one or more interactions from the plurality of interactions containing a search element that is relevant to the marketing campaign; and
calculating an information admittance metric for the user based on a comparison of the one or more terms associated with the marketing campaign and one or more terms from the identified one or more interactions containing the search element.

12. The method of claim 1, wherein determining the influence level comprises weighting the popularity metric and the relevance metric using different weighting factors.

13. The method of claim 12, wherein determining the influence level further comprises weighting the popularity metric more heavily than the relevance metric.

14. The method of claim 1, wherein the plurality of interactions comprises one or more communications from the user to one or more co-users of the social networking system.

15. In a networking environment for communicating electronic content, a method for determining influence of search elements within a social media community, comprising:
identifying, using at least one processor, one or more terms associated with a marketing campaign;
accessing, using the at least one processor, a search element context for a search element, the search element context comprising information associated with one or more uses of the search element in social networking communications;
determining, using the at least one processor, a popularity metric for the search element based on a number of the one or more uses of the search element in social networking communications;
determining, using the at least one processor, a relevance metric for the search element with regard to the marketing campaign based on a comparison of the one or more terms associated with the marketing campaign and one or more terms associated with the search element; and
determining, using the at least one processor, an influence score for the search element based on the popularity metric and the relevance metric.

16. The method of claim 15, wherein the one or more terms associated with the search element comprise one or more terms that are included within one or more interactions for users of the social networking system.

17. The method of claim 15, wherein the search element comprises a hashtag, a link, or a search term.

18. The method of claim 15, wherein determining the relevance metric for the search element comprises:
calculating the relevance metric based on a comparison of the terms associated with the marketing campaign and one or more terms included within the social networking communications.

19. In a networking environment for communicating electronic content, a system for determining influence of members within a social networking community, comprising:
at least one processor; and
at least one non-transitory computer-readable storage medium storing instructions thereon that, when executed by the at least one processor, cause the system to:
identify one or more terms associated with a marketing campaign;
access a user context for a user of a social networking system, the user context comprising information associated with a plurality of interactions for the user and information associated with one or more co-users of the social networking system associated with the user;
determine a popularity metric for the user;
determine a relevance metric for the user with regard to the marketing campaign based on a comparison of the one or more terms associated with the marketing campaign and the user context; and
determine an influence level of the user for the marketing campaign based on a combination of the popularity metric and the relevance metric.

20. The system of claim 18, wherein the instructions further cause the system to:
determine an influence level for each user within a group of users;
identify, within the group of users, one or more influential users having a higher influence level than the other users within the group of users; and
provide marketing content associated with the marketing campaign to the group of users by way of the identified one or more influential users.
